(19) United States
(12) Patent Application Publication
(10) Pub. No.: US 2019/0278145 A1
(43) Pub. Date: Sep. 12, 2019

(54) DISPLAY PANEL

(71) Applicant: Sharp Kabushiki Kaisha, Sakai City, Osaka (JP)

(72) Inventors: Kohhei TANAKA, Sakai City (JP); Tomohiro KIMURA, Sakai City (JP); Takayuki NISHIYAMA, Sakai City (JP); Ryo YONEBAYASHI, Sakai City (JP)

(21) Appl. No.: 16/336,490

(22) PCT Filed: Sep. 22, 2017
(86) PCT No.: PCT/JP2017/034242

§ 371 Date: Mar. 26, 2019

(30) Foreign Application Priority Data
Sep. 27, 2016 (JP) 2016-188580

(51) Int. Cl. G02F 1/1362; G02F 1/1345; G02F 1/1368; G09G 3/36; G02F 1/1335; G02F 1/1343

(52) U.S. Cl. CPC G02F 1/136286; G02F 1/13454; G02F 1/1368; G02F 2201/123; G02F 1/133553; G02F 1/134309; G09G 2300/0426; G09G 3/3677

(57) ABSTRACT

The invention provides a display panel that achieves narrowing at least a frame region provided with a drive circuit configured to supply a data signal. The display panel includes an active matrix substrate (10) and a counter substrate. The active matrix substrate (10) includes a data signal supplier (14) configured to supply a data signal to the frame region provided with first ends of data lines (12). The active matrix substrate (10) further includes connection lines (120P) connected to the data signal supplier (14) in the frame region. The data lines (12) include data lines (12P) connected to the data signal supplier (14) via the connection lines (120P).

### TECHNICAL FIELD

The present invention relates to a display panel.

### BACKGROUND ART

US 2008/0018583 A discloses a display device including row driver circuitry and column driver circuitry provided outside an array substrate having a semicircular shape and aligned transversely along a linear side of the array substrate, and row conductors and column conductors disposed on the array substrate and connected to the row driver circuitry and the column driver circuitry, respectively. US 2008/0018583 A further discloses spurs for connection between the row conductors and the row driver circuitry. The spurs are provided in parallel with the column conductors in a display region, and extend from connecting locations with the row conductors to the row driver circuitry. According to US 2008/0018583 A, all the column conductors extend to the column driver circuitry and are directly connected to the column driver circuitry so as to each receive a data signal from the column driver circuitry.

### DISCLOSURE OF INVENTION

According to US 2008/0018583 A, the row driver circuitry and the column driver circuitry are disposed in a portion of a frame region along the identical side of the array substrate, and the row driver circuitry and the row conductors are connected via the spurs, to achieve the display device having a semicircular shape. The spurs and the column conductors are provided perpendicularly to the row conductors in the display region, but need to extend at angles to the row driver circuitry or the column driver circuitry in the frame region. This configuration fails to achieve narrowing the frame region.

It is an object of the present invention to provide a display panel that achieves narrowing at least a portion of a frame region provided with a drive circuit configured to supply a data signal.

A display panel according to an embodiment of the present invention includes an active matrix substrate and a counter substrate disposed to be opposed to the active matrix substrate, in which the active matrix substrate includes: a plurality of gate lines; a plurality of data lines crossing the plurality of gate lines; a data signal supplier disposed in a first portion of a frame region and configured to supply each of the data lines with a data signal; and a plurality of connection lines connecting part of the plurality of data lines to the data signal supplier; and the plurality of connection lines is connected respectively to the part of the plurality of data lines in a display region.

The present invention achieves narrowing at least a portion of the frame region provided with a drive circuit configured to supply a data signal.

### BRIEF DESCRIPTION OF DRAWINGS

FIG. 1 is a sectional view of a display device according to a first embodiment.

FIG. 2A is a pattern diagram depicting a schematic configuration of an active matrix substrate depicted in FIG. 1.

FIG. 2B is an enlarged pattern diagram of part of the active matrix substrate depicted in FIG. 2A.

FIG. 3 is an enlarged pattern diagram of a region including pixels provided with part of connection lines connected to a source driver 14B depicted in FIG. 2A.

FIGS. 4(a) and 4(b) are sectional views depicting structures of a pixel provided with dummy lines and a pixel provided with a contact hole CHa depicted in FIG. 3.

FIG. 5 is a pattern diagram depicting a schematic configuration of an active matrix substrate according to a modification example of the first embodiment.

FIG. 6 is a pattern diagram depicting a schematic configuration of an active matrix substrate according to a second embodiment.

FIG. 7 is a diagram of the active matrix substrate depicted in FIG. 6 and excluding data lines.

FIG. 8 is a diagram of an exemplary equivalent circuit of a gate driver according to the second embodiment.

FIG. 9 is a timing chart indicating potential variation of internal lines, gate lines, and clock signals in the gate driver depicted in FIG. 8.

FIG. 10A is an enlarged pattern diagram of pixels provided with part of elements of gate drivers configured to switch gate lines in even rows into a selected state.

FIG. 10B is an enlarged pattern diagram of pixels provided with remaining elements of the gate drivers depicted in FIG. 10A.

FIG. 10C is an enlarged pattern diagram of pixels provided with still remaining elements of the gate drivers depicted in FIGS. 10A and 10B and pixels provided with connection lines 120P.

FIG. 11 is a pattern diagram depicting a schematic configuration of an active matrix substrate according to a modification example of the second embodiment.

FIG. 12 is a pattern diagram depicting an exemplary configuration of a pixel in a VA mode according to a third embodiment.

FIG. 13 is a pattern diagram depicting an exemplary configuration of a pixel in an FFS mode according to the third embodiment.

FIG. 14A is a pattern diagram depicting an exemplary configuration of a pixel provided with connection lines 120P in an active matrix substrate according to a fourth embodiment.

FIG. 14B is a sectional view of a display panel taken along line A-A indicated in FIG. 14A.

FIG. 15 is a pattern diagram depicting a schematic configuration of an active matrix substrate according to a modification example 1.

### DESCRIPTION OF EMBODIMENTS

A display panel according to an embodiment of the present invention includes an active matrix substrate and a counter substrate disposed to be opposed to the active matrix substrate, in which the active matrix substrate includes: a plurality of gate lines; a plurality of data lines crossing the plurality of gate lines; a data signal supplier disposed in a first portion of a frame region and configured to supply each of the data lines with a data signal; and a plurality of connection lines connecting part of the plurality of data lines to the data signal supplier; and the plurality of connection lines is connected respectively to the part of the plurality of data lines in a display region (a first configuration).

According to the first configuration, the data signal supplier, which is configured to supply each of the data lines with the data signal, is disposed in the frame region and is connected to the plurality of connection lines. The plurality of connection lines is connected to part of the plurality of data lines in the display region. In other words, only remaining data lines other than the part of the plurality of data lines are directly connected to the data signal supplier. In comparison to a case where all the data lines are directly connected to the data signal supplier, this configuration achieves narrowing a width along the extending data lines of the frame region provided with the data signal supplier.

Optionally, in the first configuration, the active matrix substrate further includes a gate line drive circuit connected to the plurality of gate lines and configured to sequentially switch the plurality of gate lines into a selected state, and the gate line drive circuit is disposed in a second portion that is different from the first portion of the frame region and is provided with at least first ends of the plurality of gate lines (a second configuration).

The second configuration includes the gate line drive circuit disposed in the portion of the frame region provided with the first ends of the gate lines, to achieve narrowing the width along the extending data lines of the frame region provided with the data signal supplier.

Optionally, in the first configuration, the active matrix substrate further includes a gate line drive circuit connected to the plurality of gate lines and configured to sequentially switch the plurality of gate lines into a selected state, and the gate line drive circuit is disposed in a region of the display region not provided with the plurality of connection lines (a third configuration).

The third configuration includes the gate line drive circuit disposed in the display region, to achieve narrowing the frame region in comparison to a case where the gate line drive circuit is disposed outside the display region.

In any one of the first to third configurations, the active matrix substrate may further include a plurality of pixel electrodes disposed in a plurality of pixels configuring the display region, and a transparent electrode disposed between the pixel electrodes and the connection lines in at least the pixels, in the plurality of pixels, provided with the plurality of connection lines (a fourth configuration).

The fourth configuration includes the transparent electrode provided between the connection lines and the pixel electrodes disposed in the display region, to prevent the pixel electrodes from being influenced by potential variation of the connection lines.

Optionally, in any one of the first to fourth configurations, the display panel further includes a liquid crystal layer provided between the active matrix substrate and the counter substrate, in which each of the pixels has a plurality of regions having different orientation states of the liquid crystal layer, and each of the connection lines has a portion disposed in the display region and overlapped in a planar view at least partially with a boundary of the plurality of regions in each of the pixels (a fifth configuration).

According to the fifth configuration, the portion of the connection lines disposed in the display region are overlapped in a planar view at least partially with the boundary between the plurality of regions having the different orientation states of the liquid crystal layer in each of the pixels. In comparison to a case where the connection lines are not overlapped with the boundary between the plurality of regions having the different orientation states of the liquid crystal layer, this configuration suppresses deterioration in transmissivity of the pixels due to disposition of the connection lines.

Optionally, in any one of the first to fourth configurations, the display panel further includes a liquid crystal layer provided between the active matrix substrate and the counter substrate, in which the active matrix substrate further includes a plurality of pixel electrodes disposed in a plurality of pixels configuring the display region, and a plurality of reflecting electrodes being in contact respectively with the plurality of pixel electrodes, disposed between the pixel electrodes and the liquid crystal layer, and configured to reflect light from the counter substrate toward the counter substrate (a sixth configuration).

The sixth configuration enables image display with use of the light from the counter substrate reflected by the reflecting electrodes, to achieve reduction in electric power consumption necessary for the image display.

In any one of the first to sixth configurations, the active matrix substrate and the counter substrate may each have a nonrectangular shape (a seventh configuration).

The seventh configuration enables provision of a display device having a nonrectangular shape.

### First Embodiment

Embodiments of the present invention will be described in detail below with reference to the drawings. Identical or corresponding portions in the drawings will be denoted by identical reference signs and will not be described repeatedly. For clearer description, the drawings to be referred to hereinafter may depict simplified or schematic configurations or may not depict some of constructional elements. The constructional elements in each of the drawings may not necessarily be depicted in actual dimensional ratios.

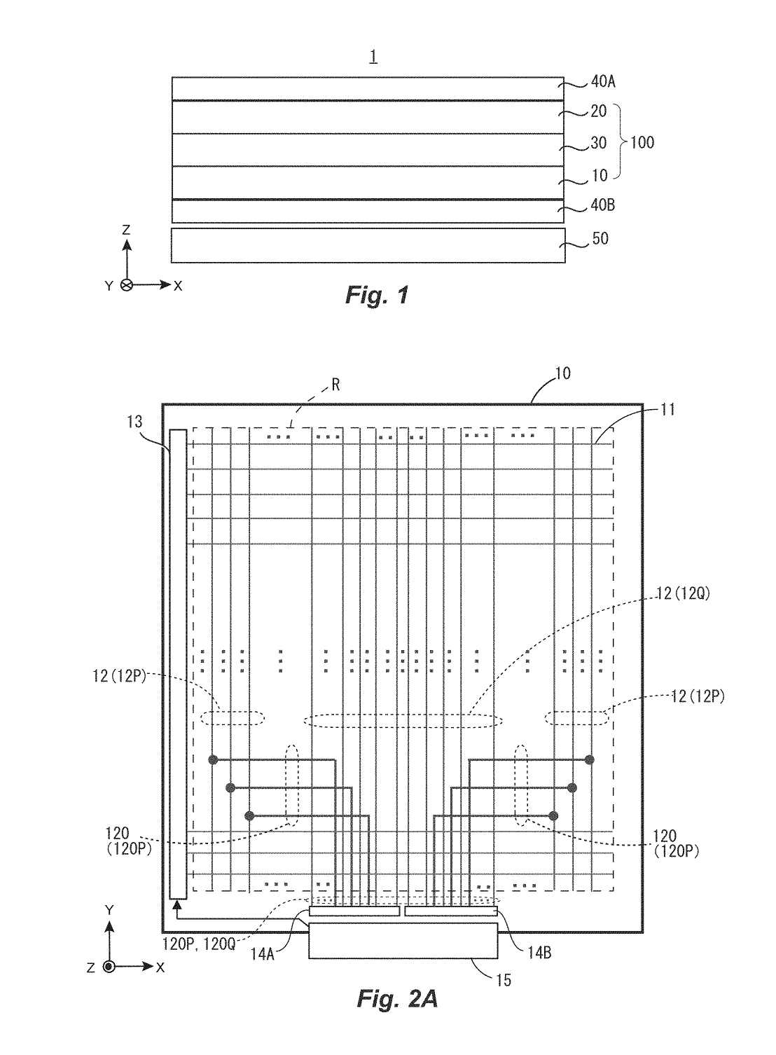

FIG. 1 is a sectional view of a display device 1 according to the present embodiment. The display device 1 according to the present embodiment includes a display panel 100 having an active matrix substrate 10, a counter substrate 20, and a liquid crystal layer 30 interposed between the active matrix substrate 10 and the counter substrate 20, a pair of polarizing plates 40A and 40B, and a backlight unit 50. The display panel 100 according to the present embodiment is configured by a transmissive liquid crystal panel, and the active matrix substrate 10 and the counter substrate 20 each have a rectangular shape.

(Active Matrix Substrate)

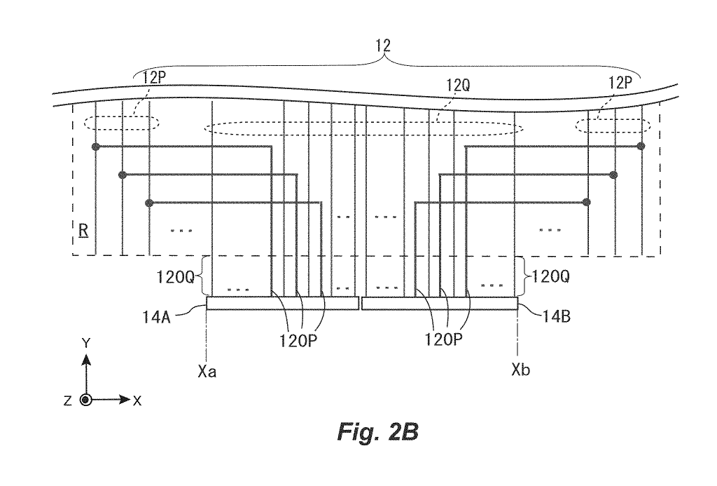

FIG. 2A is a pattern diagram depicting a schematic configuration of the active matrix substrate 10. The active matrix substrate 10 is provided, on a surface adjacent to the liquid crystal layer 3 (see FIG. 1), with a plurality of gate lines 11 and a plurality of data lines 12. The active matrix substrate 10 includes a plurality of pixels defined by the gate lines 11 and the data lines 12, and the plurality of pixels is provided in a region serving as a display region R of the active matrix substrate 10.

Each of the pixels is provided with a pixel electrode and a switching element used for image display and connected to the pixel electrode. Examples of the switching element include a thin film transistor.

The active matrix substrate 10 includes a gate line drive unit 13 disposed in a region (frame region) outside the display region R and adjacent to first ends of the gate lines 11. The gate line drive unit 13 includes gate drivers (gate line drive circuits) provided correspondingly for the gate lines 11 and each including a plurality of switching elements. The gate lines 11 are connected correspondingly to the gate drivers and are sequentially switched into a selected state by the gate drivers.

The active matrix substrate 10 includes a control circuit 15 connected via a flexible substrate and configured to supply the gate line drive unit 13 with a control signal. The control circuit 15 is electrically connected to the gate line drive unit 13.

The active matrix substrate 10 further includes a source driver (data signal supplier) 14 (14A and 14B) mounted in accordance with a chip on glass (COG) method or a system on glass (SOG) method in a portion of the frame region adjacent to first ends of the data lines 12. The source driver 14 is connected to data lines 12Q as part of the plurality of data lines 12, and a plurality of connection lines 120P. The source driver 14 supplies each of the connection lines 120P and the data lines 12Q with a voltage signal according to image data. The connection lines 120P are provided correspondingly for data lines 12P other than the data lines 12Q, and each supply the corresponding data line 12 with the voltage signal received from the source driver 14. The source driver 14 is exemplarily mounted in accordance with the COG method or the SOG method. The source driver 14 functioning as the data signal supplier may alternatively include a terminal to be supplied with a voltage signal according to image data.

FIG. 2B is an enlarged view of the data lines 12, the connection lines 120P, and the source drivers 14A and 14B depicted in FIG. 2A. The data lines 12 according to the present embodiment are disposed in the display region R. The data lines 12Q among the data lines 12 are directly connected to the source driver 14 by extensions 120Q extended to the frame region. The connection lines 120P are provided at least partially in the frame region and are directly connected to the source driver 14. FIG. 2B depicts exemplary disposition in which all the connection lines 120P are disposed substantially in parallel with the data lines 12 in the frame region, extend from the source driver 14 to be bent in the display region R, and are connected co to the data lines 12P other than the data lines 12Q in the display region R.

According to this exemplary disposition, the data lines 12Q disposed between a first end Xa of the source driver 14A and a first end Xb of the source driver 14B are directly connected to the source driver 14 by the extensions 120Q disposed in the frame region. The data lines 12P are connected to the source driver 14 via the connection lines 120P extended from the frame region to the data lines 12P in the display region R.

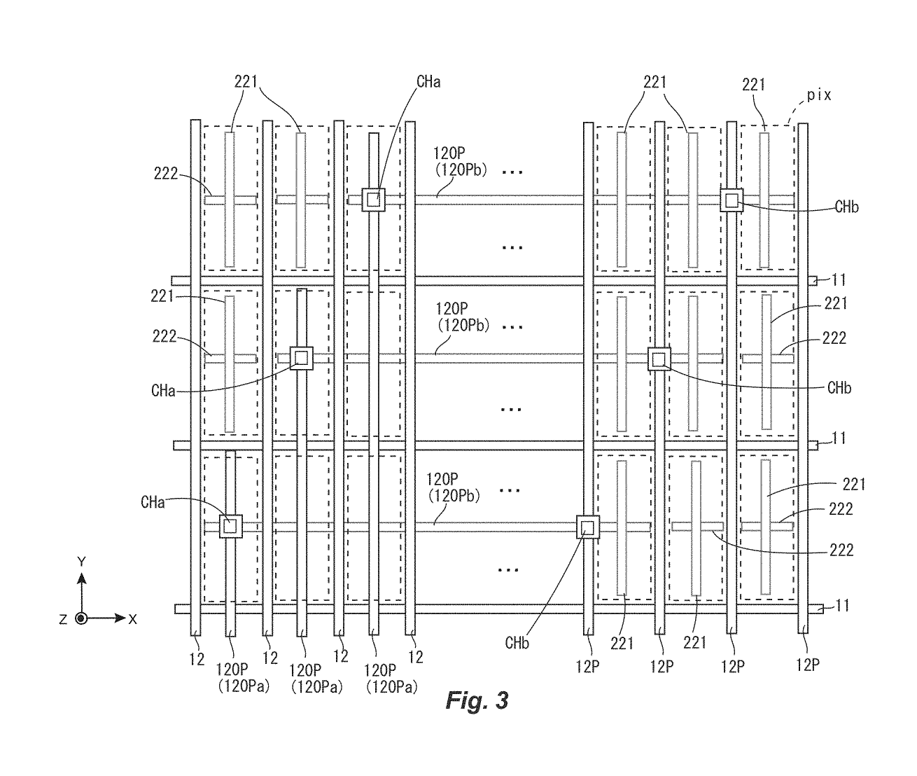

The connection lines 120P will be specifically described below. FIG. 3 is an enlarged pattern diagram of part of the display region including the pixels provided with part of the connection lines 120P connected to the source driver 14B depicted in FIG. 2A.

As depicted in FIG. 3, the connection lines 120P each include a partial line 120Pa disposed between one of the data lines 12 and the data line 12 adjacent thereto and extending along a Y axis in each pixel pix, and a partial line 120Pb extending along an X axis from the pixel pix provided with the partial line 120Pa.

The partial line 120Pa is made of a material same as a material for the data lines 12, and is provided in a layer including the data lines 12. The partial line 120Pb is made of a material same as a material for the gate lines 11, and is provided in a layer including the gate lines 11. The partial lines 120Pa and 120Pb are connected to each other via a contact hole CHa, and the partial line 120Pb is connected to a corresponding one of the data lines 12P via a contact hole CHb. The partial line 120Pa in each of the connection lines 120P is directly connected to the source driver 14 to be provided with a voltage signal according to image data, and the voltage signal is transmitted from the partial line 120Pa to the corresponding data line 12 via the partial line 120Pb.

Among the data lines 12 according to the present embodiment, the data lines 12Q are connected to the source driver 14 by the extensions 120Q disposed in the frame region, and the data lines 12P are connected to the source driver 14 via the connection lines 120P extended from the frame region into the display region R. The connection lines 120P are disposed substantially in parallel with the data lines 12 in the portion of the frame region provided with the source driver 14, and extend to be bent in the display region R. In comparison to a case where all the data lines 12 are directly connected to the source driver 14, this configuration achieves narrowing a width along the extending data lines 12 of the frame region provided with the source driver 14.

As depicted in FIG. 3, each of the pixels pix including none or only one of the partial lines 120Pa and 120Pb is provided with both or either one of dummy lines 221 and 222.

Similarly to the partial line 120Pa, the dummy line 221 is made of a material same as the material for the data lines 12, is disposed substantially at the center in the pixel pix, and extends in parallel with the data lines 12. Similarly to the partial line 120Pb, the dummy line 222 is made of a material same as the material for the gate lines 11, is disposed in parallel with the gate lines 11 in the pixel pix, and crosses the partial line 120Pa.

The dummy lines 221 and 222 are provided in this manner to achieve equal aperture ratios of the pixels pix. This configuration achieves reduction in luminance unevenness in comparison to a configuration including none of the dummy lines 221 and 222.

(Sectional Structure)

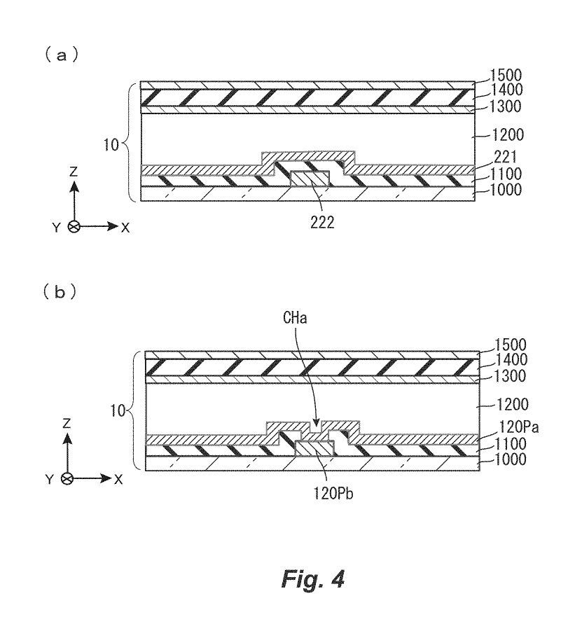

FIGS. 4(a) and 4(b) depict sectional structures of the pixel pix provided with the dummy lines 221 and 222 and the contact hole CHa connecting the dummy lines 221 and 222 depicted in FIG. 3, respectively.

FIGS. 4(a) and 4(b) each depict a glass substrate 1100 provided thereon with the dummy line 222 and the partial line 120Pb. There is provided a gate insulating film 1100 covering the dummy line 222 as depicted in FIG. 4(a) and partially covering the partial line 120Pb as depicted in FIG. 4(b). FIG. 4 (a) depicts the dummy line 221 covering the gate insulating film 1100. As depicted in FIG. 4(b), the partial line 120Pa covering the gate insulating film 1100 and connected to the partial line 120Pb is disposed on the gate insulating film 1100.

The dummy line 222 and the partial line 120Pa are provided thereon with an organic insulating film 1200 that is provided thereon with an auxiliary capacitance electrode 1300 configured as a transparent electrode. The auxiliary capacitance electrode 1300 is provided thereon with an inorganic insulating film 1400 that is provided thereon with a pixel electrode 1500 configured as a transparent electrode.

The auxiliary capacitance electrode 1300 is disposed to be overlapped with the partial lines 120Pa and 120Pb, so that the pixel electrode 1500 is unlikely to be influenced by potential variation due to the voltage signal supplied from the source driver 14 to the partial lines 120Pa and 120Pb. This configuration thus suppresses deterioration in display quality. The auxiliary capacitance electrode 1300 is provided at each of the pixels pix according to the exemplary disposition. However, the auxiliary capacitance electrode 1300 has only to be provided at each of the pixels pix including the partial line 120Pa or 120Pb.

(Counter Substrate)

With reference to FIG. 1 again, the counter substrate 20 includes a counter electrode, color filters having colors of red (R), green (G), and blue (B), and a black matrix having a color of black or the like, which are provided on a surface adjacent to the liquid crystal layer 30 (all not depicted).

The counter electrode is disposed to be overlapped with the entire display region R of the active matrix substrate 10. The color filters of red (R), green (G), and blue (B) are positioned correspondingly at the pixels of the active matrix substrate 10. The black matrix is provided in a region excluding openings of the pixels of the active matrix substrate 10. The counter electrode may not be provided in a case where the liquid crystal layer 30 is oriented in a fringe field switching (FFS) mode.

(Modification Examples)

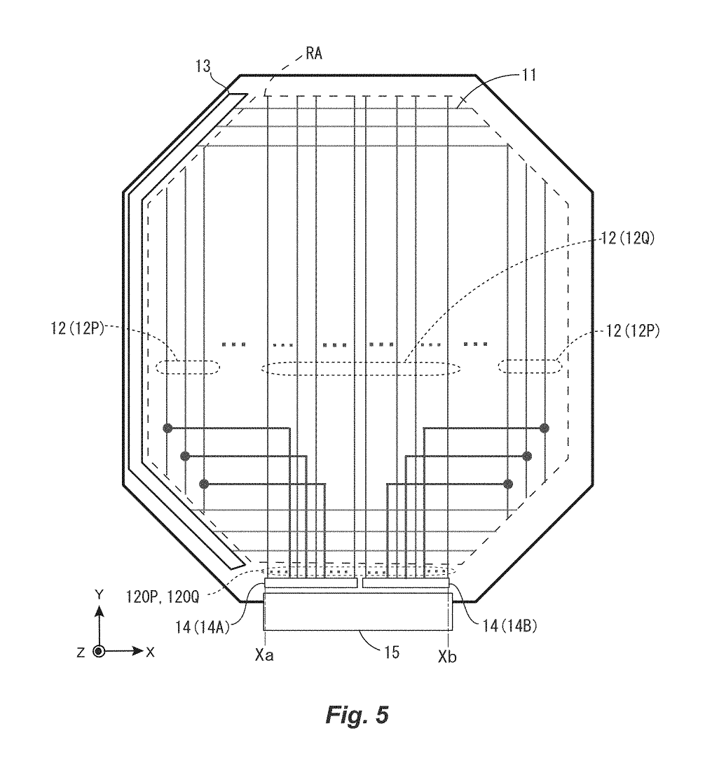

The above example refers to the active matrix substrate 10 having the rectangular shape. The active matrix substrate 10 may alternatively have a nonrectangular shape. FIG. 5 depicts an exemplary active matrix substrate having a nonrectangular shape. In FIG. 5, components similar to those according to the first embodiment are denoted by identical reference signs referred to in the first embodiment.

FIG. 5 depicts an active matrix substrate 10A having an octagonal shape. Although not depicted, this example provides a counter substrate also having an octagonal shape similarly to the active matrix substrate 10A.

The active matrix substrate 10A includes the plurality of gate lines 11 and the plurality of data lines 12 having lengths unequal to each other, and has a display region RA having an octagonal shape substantially equal to its outline.

The active matrix substrate 10A includes the gate line drive unit 13 disposed outside the display region RA, in a region adjacent to the first ends of the gate lines 11. As in the first embodiment, the portion of the frame region adjacent to the first ends of the data lines 12 is provided with the source drivers 14A and 14B that are connected to the connection lines 120P and the extensions 120Q of the data lines 12.

Among the data lines 12, the data lines 12Q disposed between the first end Xa of the source driver 14A and the first end Xb of the source driver 14B are directly connected to the source driver 14A or 14B by the extensions 120Q of the data lines 12Q. The data lines 12P are connected to the source driver 14A or 14B via the connection lines 120P connected in the display region RA. Also in this case, the connection lines 120P are disposed substantially in parallel with the data lines 12 in the portion of the frame region provided with the source driver 14, and extend to be bent in the display region R. This configuration achieves narrowing the width along the extending data lines 12 of the frame region provided with the source driver 14.

### Second Embodiment

The first embodiment described above exemplifies the case where the gate line drive unit 13 is disposed outside the display region. The present embodiment exemplifies a case where the gate line drive unit 13 is disposed inside the display region.

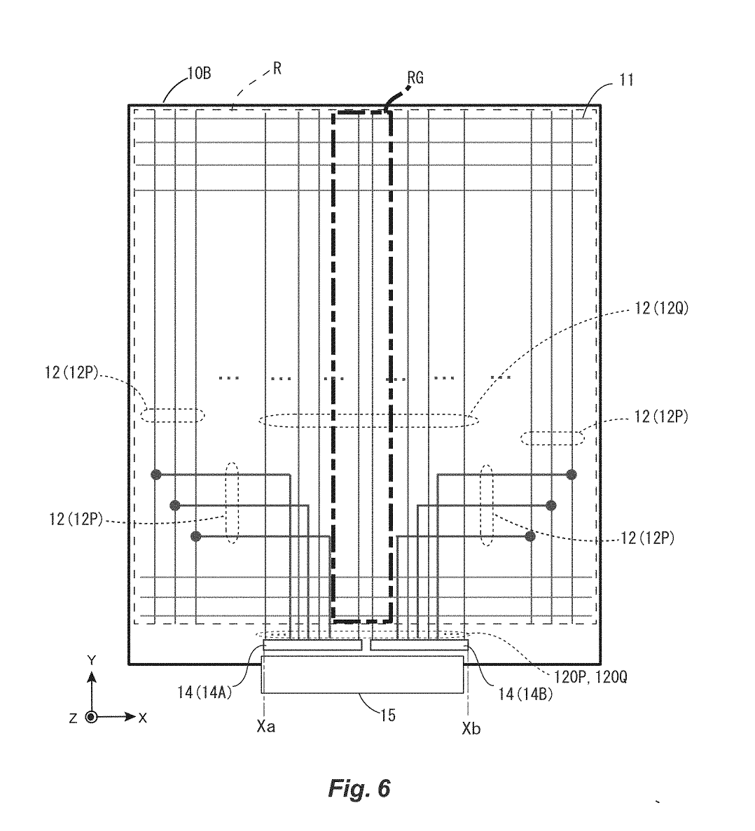

FIG. 6 is a pattern diagram depicting a schematic configuration of an active matrix substrate 10B according to the present embodiment. In FIG. 6, components similar to those included in the active matrix substrate 10 according to the first embodiment are denoted by similar reference signs referred to in the first embodiment.

The active matrix substrate 10B has the display region R including a region RG provided with the gate line drive unit 13 and the gate drivers that is provided correspondingly for the gate lines 11. The region RG is disposed so as not to include the connection lines 120P. This example provides the region RG disposed at the center in an X-axis direction of the display region R.

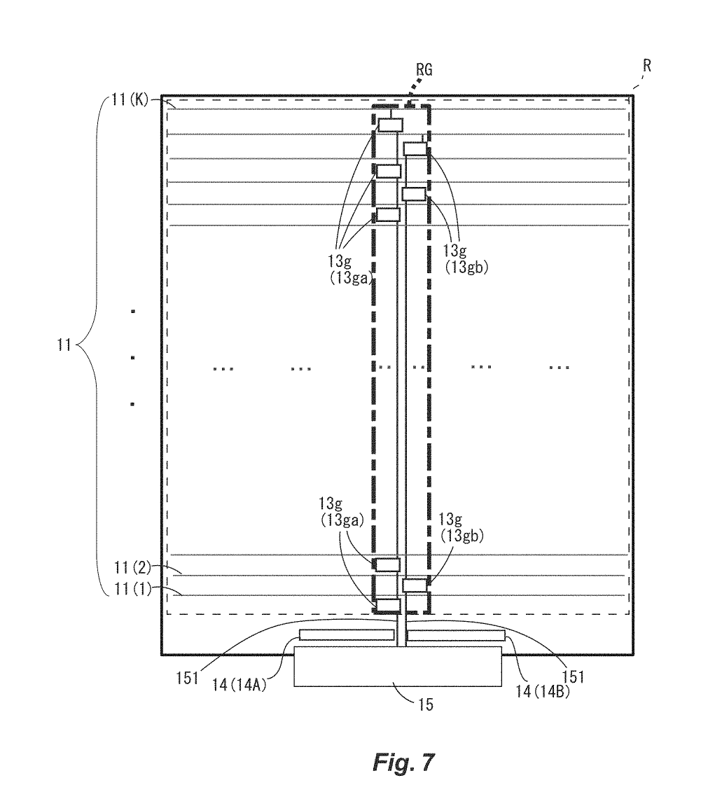

FIG. 7 is a diagram of the active matrix substrate 10B depicted in FIG. 6 and excluding the data lines 12. As depicted in FIG. 7, the active matrix substrate 10B according to the present embodiment is provided with K (K is an integer) gate lines 11(1) to 11(K), and a plurality of gate drivers 13g including gate drivers 13ga configured to switch the gate lines 11 in odd rows, among the K gate lines 11, into the selected state and gate drivers 13gb configured to switch the gate lines 11 in even rows into the selected state. The gate drivers 13g are connected to the control circuit 15 via lines 151 and are each driven in accordance with a control signal supplied from the control circuit 15.

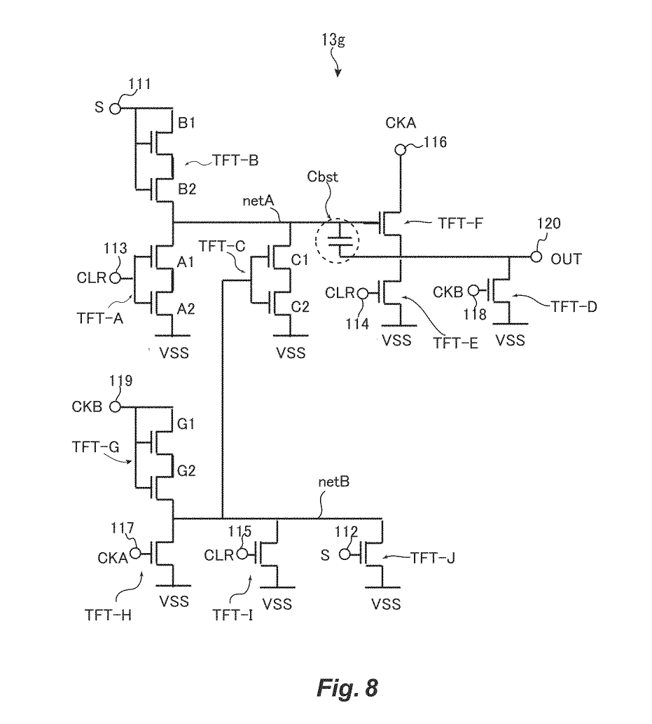

The gate drivers 13g will be described below in terms of their exemplary configuration. Each of the gate drivers 13g is configured by a plurality of elements including thin film transistors (TFTs). FIG. 8 is a diagram of an exemplary equivalent circuit included in the gate driver according to the present embodiment. As depicted in FIG. 8, the gate driver 13g includes TFT-A to TFT-J, a capacitor Cbst, terminals 111 to 120, and a terminal group configured to receive a power supply voltage signal at a low level.

The terminal 120 is connected to the gate line 11 to be switched into the selected state by the gate driver 13g, and the terminal 111 is connected to the gate line 11 in a preceding row. In the gate driver 13g configured to switch the gate line 11 in an n-th (n is an integer and satisfying n≥2) row into the selected state, the terminal 111 of the gate driver 13g is connected to the gate line 11 in an n−1-th row.

In each of the gate drivers 13ga configured to switch the gate lines 11 in the odd rows into the selected state, the terminals 111 and 112 each receive a set signal (S) via the gate line 11 in the preceding row. The terminals 111 and 112 of the gate driver 13ga configured to switch the gate line 11(1) into the selected state each receive a gate start pulse signal (S) outputted from the control circuit 15. The terminals 113 to 115 each receive a reset signal (CLR) outputted from the control circuit 15. The terminals 116 and 117 each receive a clock signal (CKA) supplied from the control circuit 15 via the line 151 (see FIG. 7). The terminals 118 and 119 each receive a clock signal (CKB) supplied from the control circuit 15 via the line 151 (see FIG. 7). The terminal 120 transmits a set signal (OUT) to the gate line 11 in a subsequent row. The clock signal (CKA) and the clock signal (CKB) are two-phase clock signals with phases reversed at each horizontal scan interval so as to have phases opposite to each other.

Each of the gate drivers 13gb configured to switch the gate lines 11 in the even rows into the selected state receives clock signals having phases opposite to the phases of the clock signals received by the gate drivers 13ga. In the gate driver 13gb, the terminals 116 and 117 each receive the clock signal (CKB) whereas the terminals 118 and 119 each receive the clock signal (CKA). The terminals 116 and 117 and the terminals 118 and 119 in each of the gate drivers 13g receive the clock signals having the phases opposite to the phases of the clock signals received by the gate drivers 13g in the adjacent rows.

The equivalent circuit depicted in FIG. 8 includes an internal line referred to as a netA and connected to a source terminal of the TFT-B, a drain terminal of the TFT-A, a source terminal of the TFT-C, and a gate terminal of the TFT-F. The equivalent circuit further includes an internal line referred to as a netB and connected to a gate terminal of the TFT-C, a source terminal of the TFT-G, a drain terminal of the TFT-H, a source terminal of the TFT-I, and a source terminal of the TFT-J.

The TFT-A includes two TFTs (A1 and A2) connected in series. The TFT-A includes gate terminals connected to the terminal 113, the A1 includes a drain terminal connected to the netA, and the A2 includes a source terminal connected to a power supply voltage terminal VSS.

The TFT-B includes two TFTs (B1 and B2) connected in series. The terminal 111 is connected to gate terminals of the TFT-B and a drain terminal of the B1 (diode connection), and the B2 includes a source terminal connected to the netA.

The TFT-C includes two TFTs (C1 and C2) connected in series. The TFT-C includes gate terminals connected to the netB, the C1 includes a drain terminal connected to the netA, and the C2 includes a source terminal connected to a power supply voltage terminal VSS.

The capacitor Cbst includes a first electrode connected to the netA and a second electrode connected to the terminal 120.

The TFT-D includes a gate terminal connected to the terminal 118, a drain terminal connected to the terminal 120, and a source terminal connected to a power supply voltage terminal VSS.

The TFT-E includes a gate terminal connected to the terminal 114, a drain terminal connected to the terminal 120, and a source terminal connected to a power supply voltage terminal VSS.

The TFT-F includes the gate terminal connected to the netA, a drain terminal connected to the terminal 116, and a source terminal connected to the output terminal 120.

The TFT-G includes two TFTs (G1 and G2) connected in series. The terminal 119 is connected to gate terminals of the TFT-G and a drain terminal of the G1 (diode connection), and the G2 includes a source terminal connected to the netB.

The TFT-H includes a gate terminal connected to the terminal 117, the drain terminal connected to the netB, and a source terminal connected to a power supply voltage terminal VSS.

The TFT-I includes a gate terminal connected to the terminal 115, a drain terminal connected to the netB, and the source terminal connected to a power supply voltage terminal VSS.

The TFT-J includes a gate terminal connected to the terminal 112, a drain terminal connected to the netB, and the source terminal connected to a power supply voltage terminal VSS.

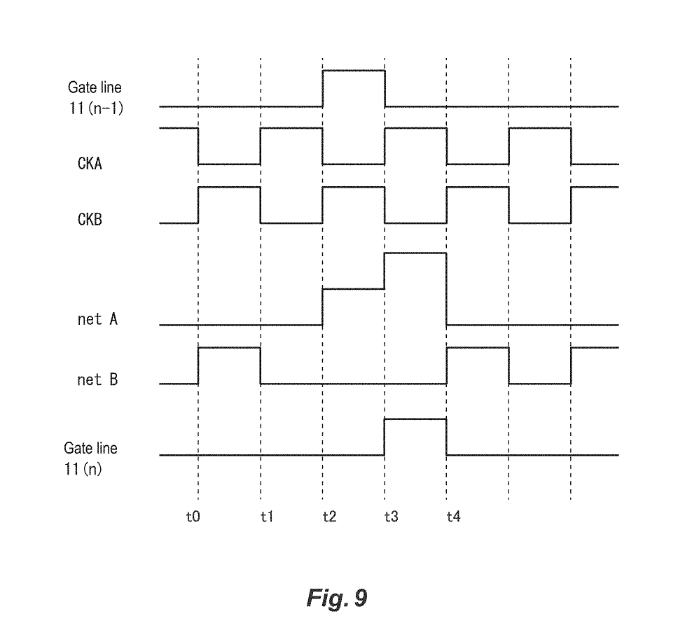

FIG. 9 is a timing chart indicating potential variation of the internal lines, gate lines 11(n) and 11(n−1), and the clock signals in the gate driver 13ga configured to switch the gate line 11(n) into the selected state. Although not included in this chart, the gate driver 13g receives, via each of the terminals 113 to 115, the reset signal (CLR) having a high (H) level for a certain period at each vertical scan interval. The reset signal (CLR) thus received changes the potential of the netA, the netB, and the gate lines 11 to a low (L) level.

From time t0 to time t1, the terminals 116 and 117 each receive the clock signal (CKA) at the L level, and the terminals 118 and 119 each receive the clock signal (CKB) at the H level. This brings the TFT-G into an ON state and the TFT-H into an OFF state, so that the netB is charged to reach the H level. Furthermore, the TFT-C and the TFT-D are brought into the ON state and the TFT-F is brought into the OFF state, so that the netA is charged to reach the L level of power supply voltage (VSS) and the terminal 120 outputs the potential at the L level.

The clock signal (CKA) reaches the H level and the clock signal (CKB) reaches the L level at the time t1, so that the TFT-G is brought into the OFF state and the TFT-H is brought into the ON state to cause the netB to be charged to reach the L level. Furthermore, the TFT-C and the TFT-D are brought into the OFF state, so that the potential of the netA is kept at the L level and the terminal 120 outputs the potential at the L level.

The clock signal (CKA) reaches the L level and the clock signal (CKB) reaches the H level at time t2, so that the terminals 111 and 112 of the gate driver 13g each receive, as the set signal (S), the potential at the H level of the gate line 11(n−1). This brings the TFT-B into the ON state, and the netA is charged to reach the H level. Furthermore, the TFT-J and the TFT-G are brought into the ON state and the TFT-H is brought into the OFF state, so that the netB is kept at the L level. The TFT-C and the TFT-F are brought into the OFF state, so that the potential of the netA is kept with no decrease. The TFT-D is in the ON state during this period, so that the terminal 120 outputs the potential at the L level.

The clock signal (CKA) reaches the H level and the clock signal (CKB) reaches the L level at time t3, so that the TFT-F is brought into the ON state and the TFT-D is brought into the OFF state. Because the capacitor Cbst is provided between the netA and the terminal 120, the netA is charged to have potential at a level exceeding the H level of the clock signal (CKA) as the potential of the terminal 116 increases in the TFT-F. The TFT-G and the TFT-J are in the OFF state and the TFT-H is in the ON state during this period, so that the potential of the netB is kept at the L level. Because the TFT-C is in the OFF state, the potential of the netA does not decrease and the terminal 120 outputs the potential at the H level of the clock signal (CKA). The gate line 11(n) connected to the terminal 120 is accordingly charged to reach the H level and is brought into the selected state.

The potential of the clock signal (CKA) reaches the L level and the potential of the clock signal (CKB) reaches the H level at time t4, so that the TFT-G is brought into the ON state and the TFT-H is brought into the OFF state to cause the potential of the netB to reach the H level. This brings the TFT-C into the ON state, and the potential of the netA reaches the L level. The TFT-D is in the ON state and the TFT-F is in the OFF state during this period, so that the terminal 120 outputs the potential at the L level to the gate line 11(n) that is switched into an unselected state.

The gate drivers 13g sequentially switch the gate lines 11 into the selected state in this manner.

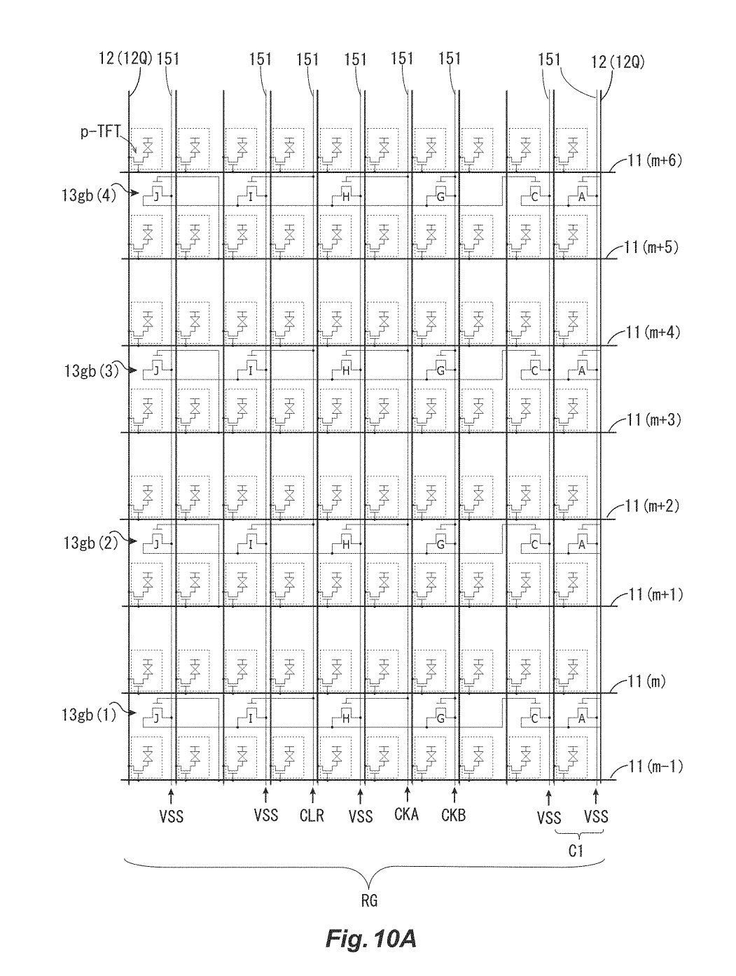

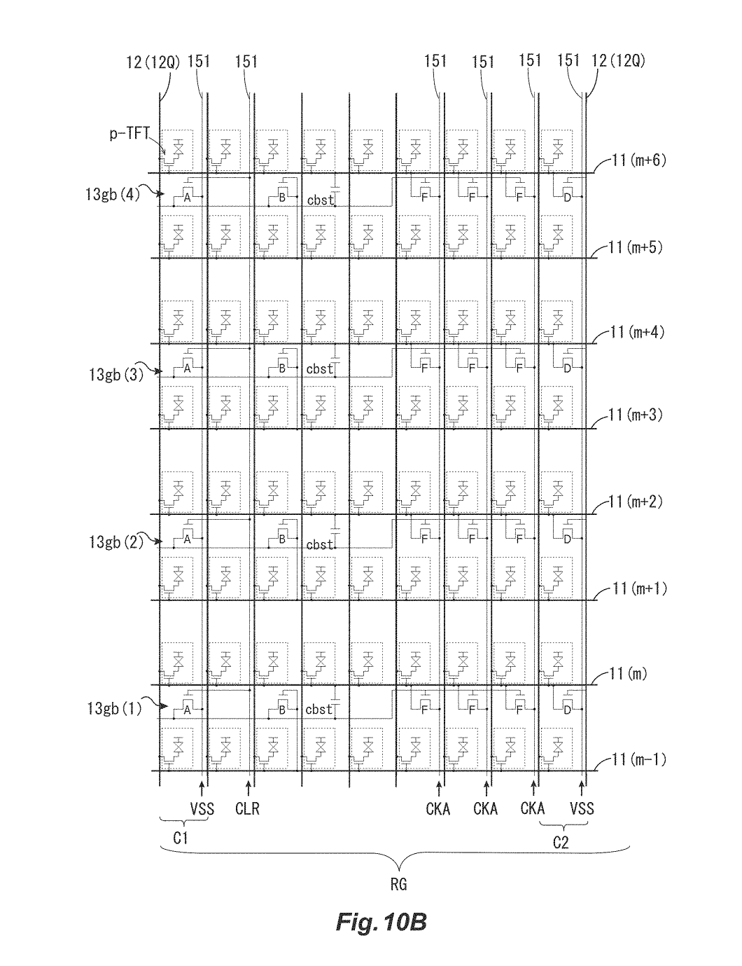

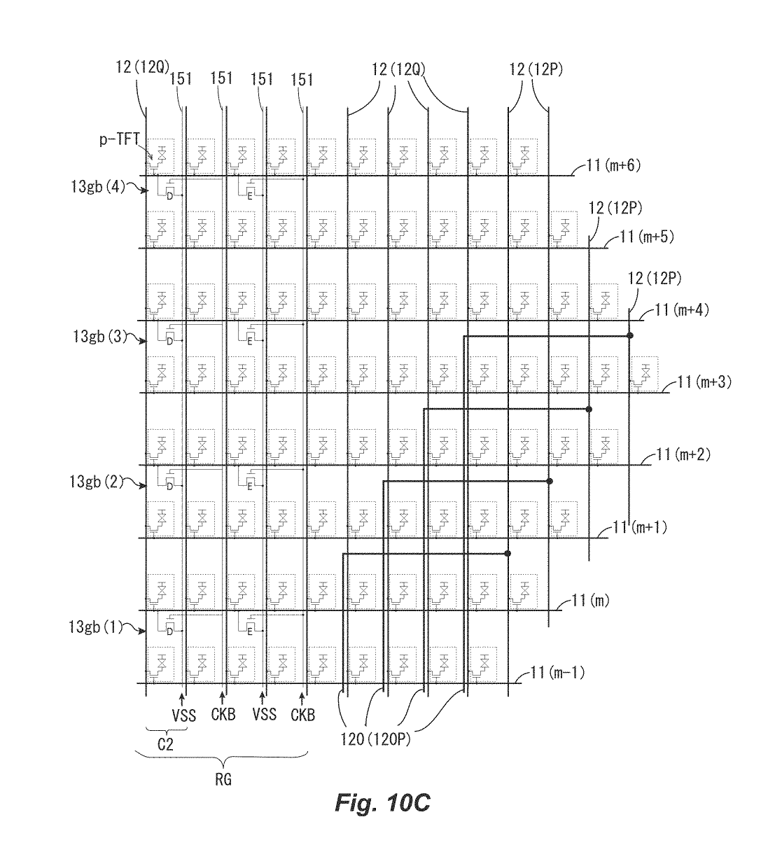

The gate drivers 13g will be described next in terms of exemplary disposition thereof. FIGS. 10A to 10C are enlarged pattern diagrams of part of the display region including the gate drivers 13gb configured to switch the gate lines 11 in the even rows into the selected state and the pixels provided with the connection lines 120P connected to the source driver 14B. FIGS. 10A and 10B depict pixel regions provided continuously at a pixel column C1, whereas FIGS. 10B and 10C depict pixel regions provided continuously at a pixel column C2. FIGS. 10A to 10C include alphabets A to J indicating the TFT-A to the TFT-J depicted in FIG. 8, respectively.

Each of the pixels depicted in FIGS. 10A to 10C is provided with the pixel electrode and a switching element p-TFT used for image display and connected to the gate line 11, the data line 12, and the pixel electrode.

The region RG depicted in each of FIGS. 10A to 10C is provided with elements of four gate drivers 13gb(1) to 13gb(4) configured to switch, into the selected state, gate lines 11(m), 11(m+2), 11(m+4), and 11(m+6) (m is an even number) in the even rows among gate lines 11(m−1) to 11(m+6).

The elements in each of the gate drivers 13gb are dispersed in the pixels disposed between the gate line 11 to be switched into the selected state and the gate line 11 in the preceding row. FIG. 10B exemplarily depicts the TFT-Fs each including three TFTs connected in series. Each of the TFT-Fs may alternatively include only one TFT. The adjacent gate drivers 13gb are connected to each other via the line 151 that is connected to the control circuit 15.

As depicted in FIG. 10C, the connection lines 120P connected to the source driver 14B are disposed in the pixels outside the region RG provided with the gate drivers 13gb and are each connected to a corresponding one of the data lines 12P.

As in the gate drivers 13gb, the elements in each of the gate drivers 13ga are dispersed in the pixels disposed between the gate line 11 to be switched into the selected state and the gate line 11 in the preceding row in the region RG. The connection lines 120P connected to the source driver 14A are disposed in the pixels outside the region RG provided with the gate drivers 13ga and are each connected to a corresponding one of the data lines 12P.

Similarly to the first embodiment, according to the present embodiment, the data lines 12P (see FIG. 6) other than the data lines 12Q disposed between the first end Xa of the source driver 14A and the first end Xb of the source driver 14B are each connected to the source driver 14 via a corresponding one of the connection lines 120P disposed in the display region R, and the gate line drive unit 13 is disposed in the display region R. This configuration achieves narrowing the portion of the frame region provided with the source driver 14 as well as narrowing the portion of the frame region adjacent to the first ends of the gate lines 11.

(Modification Examples)

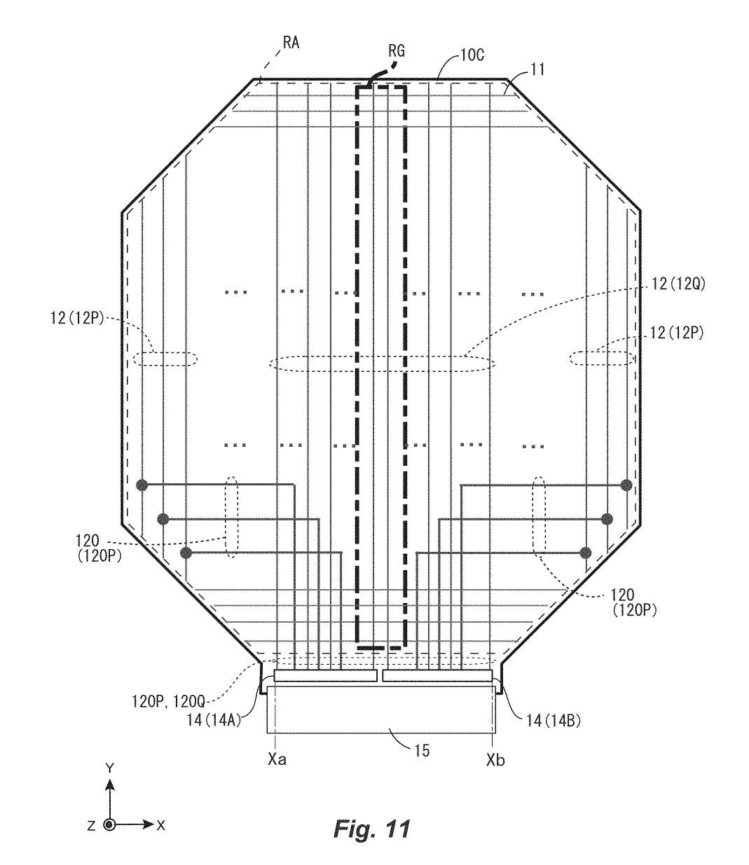

The second embodiment described above exemplifies the active matrix substrate 10B having a rectangular shape. The present invention is also applicable to an active matrix substrate 10C having an octagonal shape as exemplarily depicted in FIG. 11. Similarly to the active matrix substrate 10B having the rectangular shape, the active matrix substrate 10C includes the gate line drive unit 13 disposed in the region RG positioned at the center in the X-axis direction of the display region RA. The gate line drive unit 13 is disposed in a region not including the connection lines 120P. In comparison to the modification example of the first embodiment, such provision of the gate line drive unit 13 in the display region RA enables further narrowing the portion of the frame region adjacent to the first ends of the gate lines 11.

### Third Embodiment

The present embodiment exemplifies a case where each of the pixels according to the first or second embodiment includes a plurality of domains (regions) having different orientation states of the liquid crystal layer 30.

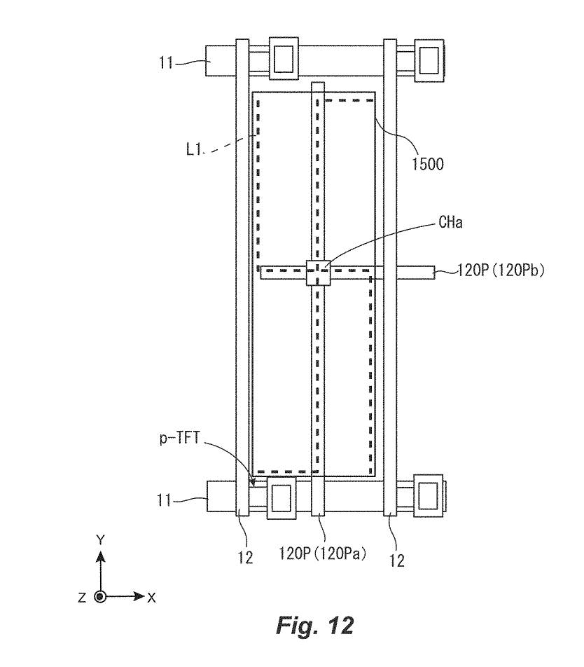

In an exemplary case where a production process includes applying light to an oriented film in a plurality of directions to orient the liquid crystal layer 30 in a vertical alignment (VA) mode, the pixel is provided with four domains having different orientation states. As depicted in FIG. 12, the pixel includes broken lines L1 defining boundaries of the domains. The broken lines L1 serve as dark lines having transmissivity lower than that of remaining portions. As depicted in FIG. 12, the connection lines 120P according to the present embodiment are disposed to be overlapped in a planar view with the dark lines L1 provided in the pixel.

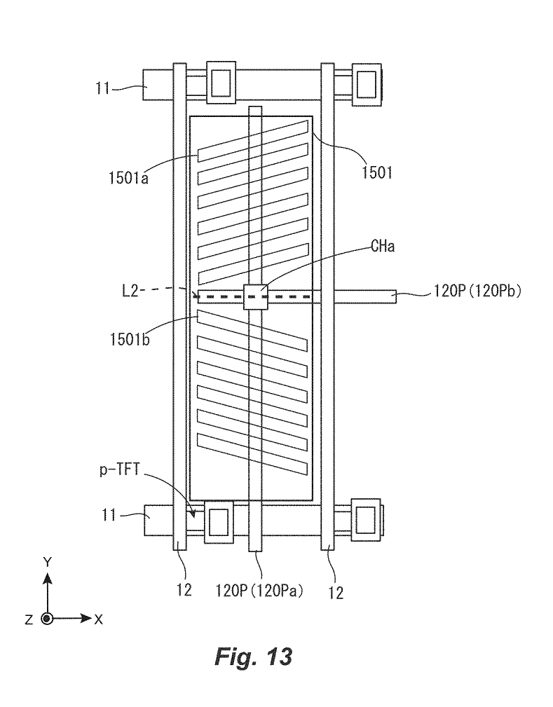

The following configuration is also applicable in the case where the liquid crystal layer 30 is oriented in the FFS mode. When the FFS mode is adopted, the pixel is provided with a pixel electrode 1501 having slits 1501a and 1501b as depicted in FIG. 13. The slits 1501a and 1501b extend in directions different from each other, and the liquid crystal layer 30 has orientation states differentiated between a region provided with the slits 1501a and a region provided with the slits 1501b. The pixel accordingly has two domains having the orientation states different from each other, and the domains are defined by a broken line L2 serving as a dark line. In this case, the connection lines 120P are disposed to be overlapped in a planar view at least partially with the dark line L2 as depicted in FIG. 13.

When the pixel includes the connection lines 120P disposed to be overlapped in a planar view at least partially with the dark lines L1 or the dark line L2, deterioration in transmissivity of the pixel due to disposition of the connection lines 120P can be suppressed in comparison to a case where the connection lines 120P are never overlapped with the dark lines L1 or the dark line L2.

### Fourth Embodiment

Each of the first and second embodiments described above exemplifies the transmissive liquid crystal panel as the display panel 100. The display panel 100 may alternatively be configured by a semi-transmissive liquid crystal panel. Described below is a case where the semi-transmissive liquid crystal panel is adopted.

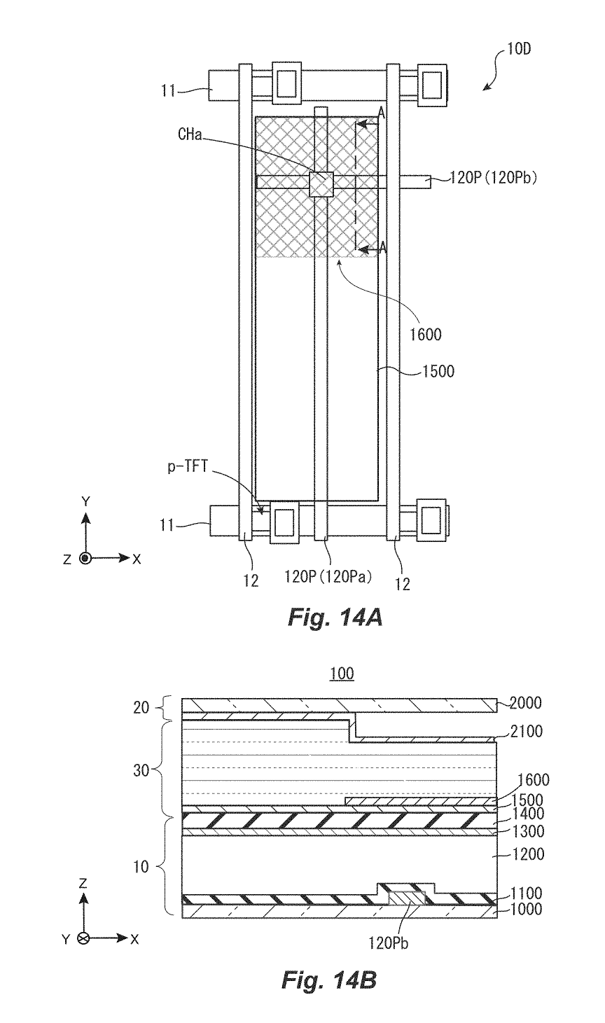

FIG. 14A is a pattern diagram of a pixel provided with the connection lines 120P in an active matrix substrate 10D according to the present embodiment. In FIG. 14A, components common with those according to the first or second embodiment are denoted by identical reference signs referred to in the first or second embodiment.

As depicted in FIG. 14A, the pixel in the active matrix substrate 10D includes a reflecting electrode 1600 smaller in area than the pixel electrode 1500. The reflecting electrode 1600 is made of a metallic material such as aluminum. The reflecting electrode 1600 is disposed to be overlapped with the pixel electrode 1500. The partial line 120Pb is disposed in a region provided with the reflecting electrode 1600, and is connected to the partial line 120Pa via the contact hole CHa.

FIG. 14B is a sectional view of the display panel 100 taken along line A-A indicated in FIG. 14A. As depicted in FIG. 14B, the active matrix substrate 10C includes the auxiliary capacitance electrode 1300 provided on the organic insulating film 1200, and the pixel electrode 1500 provided above the auxiliary capacitance electrode 1300 with the inorganic insulating film 1400 interposed therebetween. The pixel electrode 1500 is provided thereon with the reflecting electrode 1600 to be in contact with the pixel electrode 1500. The partial line 120Pb configuring the connection line 120P is overlapped with the reflecting electrode 1600 in a planar view.

The pixel electrode 1500 and the reflecting electrode 1600 are provided thereon with the liquid crystal layer 30 that is provided thereon with the counter substrate 20. The counter substrate 20 includes a counter electrode 201 disposed on a surface adjacent to the liquid crystal layer 30, of a glass substrate 2000. Although not depicted in this figure, the glass substrate 2000 and the counter electrode 201 are provided therebetween with color filters and a black matrix.

According to the present embodiment, the partial line 120Pb disposed substantially in parallel with the gate lines 11 is overlapped with the reflecting electrode 1600 in a planar view. In comparison to a case where the partial line 120Pb is not overlapped with the reflecting electrode 1600, this configuration suppresses deterioration in aperture ratio of the pixels due to disposition of the connection lines 120P.

The display device according to the present invention is exemplarily described above, but should not be limited to the configuration according to any one of the embodiments described above and can be modified in various manners. Modification examples thereof will be described below.

### Modification Example 1

The second embodiment described above exemplifies the case where the frame region includes the source drivers 14A and 14B transversely aligned adjacent to an intermediate position of the width along the X axis of the display region R, and the display region R includes the gate line drive unit 13 disposed adjacent to an intermediate position of the width along the X axis of the display region R. The present invention is also applicable to the following disposition.

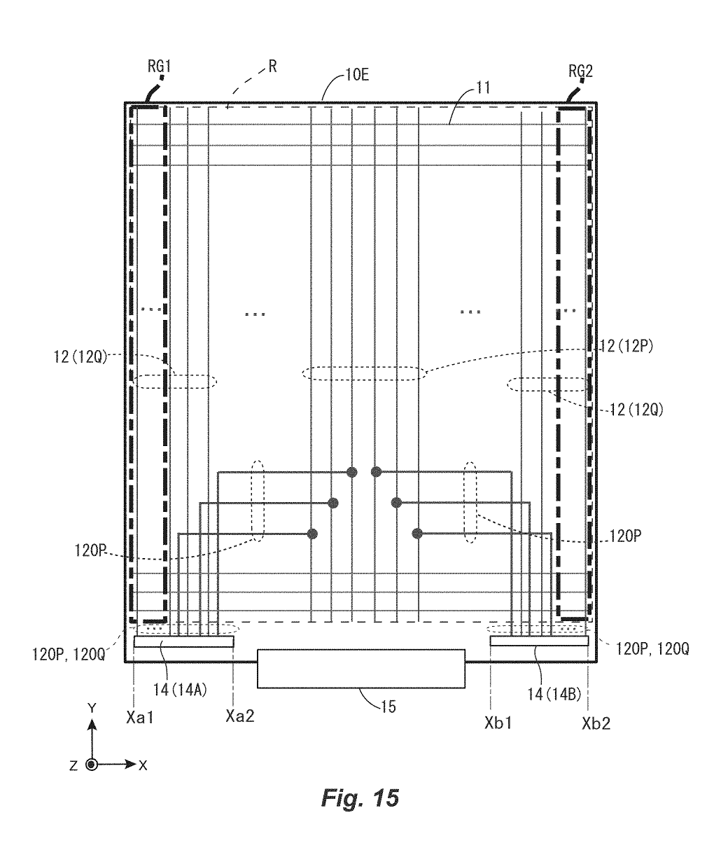

FIG. 15 is a pattern diagram depicting a schematic configuration of an active matrix substrate 10E according to the present modification example. In FIG. 15, components common with those according to the second embodiment are denoted by identical reference signs referred to in the second embodiment.

As depicted in FIG. 15, the source drivers 14A and 14B are disposed at left and right ends, respectively, of the portion of the frame region adjacent to the first ends of the data lines 12. The display region R includes regions RG1 and RG2 that are disposed at left and right ends of the display region R, respectively, and are each provided with the gate line drive unit 13. This modification example provides the gate drivers 13ga and the gate drivers 13gb (see FIG. 7) that are disposed adjacent to the respective ends of the gate lines 11 in the display region R.

The data lines 12Q disposed between a first end Xa1 and a second end Xa2 of the source driver 14A as well as between a first end Xb1 and a second end Xb2 of the source driver 14B are directly connected to the source driver 14A or 14B by the extensions 120Q disposed in the frame region. The data lines 12P are connected, in the display region R, to the connection lines 120P extended from the source driver 14A or 14B to be bent in the display region R, so as to be connected to the source driver 14A or 14B via the connection lines 120P. The present modification example achieves narrowing the width along the extending data lines 12 of the frame region disposed outside the display region R and provided with the source driver 14, as well as widths of the frame region at the respective ends of the gate lines 11.

### Modification Example 2

The first embodiment described above exemplifies the case where the gate line drive unit 13 is disposed in the portion of the frame region adjacent to the first ends of the gate lines 11. The gate line drive unit 13 may alternatively be provided in each of the portions of the frame region at the respective ends of the gate lines 11.

### Modification Example 3

The embodiments and the modification examples described above each exemplify the display panel adopting liquid crystals. The configurations described in the embodiments and the modification examples are also applicable to a display panel adopting organic electro luminescence (EL), the micro electro mechanical system (MEMS), or the like.

1. A display panel comprising an active matrix substrate and a counter substrate disposed to be opposed to the active matrix substrate, the active matrix substrate includes:
a plurality of gate lines;
a plurality of data lines crossing the plurality of gate lines;
a data signal supplier disposed in a first portion of a frame region and configured to supply each of the data lines with a data signal; and
a plurality of connection lines connecting part of the plurality of data lines to the data signal supplier; and
the plurality of connection lines is connected respectively to the part of the plurality of data lines in a display region.

2. The display panel according to claim 1, wherein
the active matrix substrate further includes
a gate line drive circuit connected to the plurality of gate lines and configured to sequentially switch the plurality of gate lines into a selected state, and
the gate line drive circuit is disposed in a second portion that is different from the first portion of the frame region and is provided with at least first ends of the plurality of gate lines.

3. The display panel according to claim 1, wherein
the active matrix substrate further includes
a gate line drive circuit connected to the plurality of gate lines and configured to sequentially switch the plurality of gate lines into a selected state, and
the gate line drive circuit is disposed in a region of the display region not provided with the plurality of connection lines.

4. The display panel according to claim 1, wherein
the active matrix substrate further includes
a plurality of pixel electrodes disposed in a plurality of pixels configuring the display region, and
a transparent electrode disposed between the pixel electrodes and the connection lines in at least the pixels, in the plurality of pixels, provided with the plurality of connection lines.

5. The display panel according to claim 1, further comprising
a liquid crystal layer provided between the active matrix substrate and the counter substrate, wherein
each of the pixels has a plurality of regions having different orientation states of the liquid crystal layer, and
each of the connection lines has a portion disposed in the display region and overlapped in a planar view at least partially with a boundary of the plurality of regions in each of the pixels.

6. The display panel according to claim 1, further comprising
a liquid crystal layer provided between the active matrix substrate and the counter substrate, wherein
the active matrix substrate further includes
a plurality of pixel electrodes disposed in a plurality of pixels configuring the display region, and
a plurality of reflecting electrodes being in contact respectively with the plurality of pixel electrodes, disposed between the pixel electrodes and the liquid crystal layer, and configured to reflect light from the counter substrate toward the counter substrate.

7. The display panel according to claim 1, wherein the active matrix substrate and the counter substrate each have a nonrectangular shape.
